(19) United States
(12) Patent Application Publication
(10) Pub. No.: US 2026/0266411 A1
(43) Pub. Date: Sep. 10, 2026

(54) CUT-COVERING ASSEMBLY WITH OPEN, EXPANDABLE, AND LOCKABLE INSERTION VALVE

(71) Applicant: Jeffrey Maichel, Mustang, OK (US)

(72) Inventor: Jeffrey Maichel, Mustang, OK (US)

(21) Appl. No.: 19/165,743

(22) PCT Filed: Mar. 18, 2024
(86) PCT No.: PCT/US2024/020476

§ 371 Date: Sep. 16, 2025

Related U.S. Application Data
(60) Provisional application No. 63/452,608, filed on Mar. 16, 2023.

(51) Int. Cl. F16L 55/105; F16K 3/02; F16K 43/00

(52) U.S. Cl. CPC F16L 55/105; F16K 3/02; F16K 43/00

(57) ABSTRACT

A method of installing a replacement valve while a pipeline is fully pressurized by use of a replacement valve body with two cylinders that match the openings of a cut pipe. Inside each of the two cylinders is a cut-covering assembly which includes a cylindrical elastomeric seal and a split tube. The replacement valve body further includes a linear moving valve in a central portion of the valve, and when the cylinder ends of the replacement valve body are positioned adjacent the bores of the cut pipeline ends, the valve can be moved to push the elastomeric seals of each of the cut-covering assemblies while expanding the cut-covering assembly in diameter when entering the bores of the cut pipeline ends, thereby covering gaps created when the pipe was cut and placing the valve pipe ends in fluid-tight engagement with the replacement valve body.

### BACKGROUND

A pipeline valve is prone to becoming corroded, obstructed by mineral and/or chemical deposits or debris, or to otherwise damaged to the point that it requires servicing in order to clean or resurface the hollow valve body interior and/or to clean, resurface, or replace the valve-stopping mechanism. One option for servicing such a valve is to stop fluid flowing through the pipeline so that the valve is not under pressure during servicing operations. However, the consequences of shutting down a pipeline may be significant. For example, shutting down a municipal water main in order to service a branch line to a subdivision results in many inconvenienced and potentially monetarily damaged water customers.

Another way to service or replace a pipeline valve is to do so without depressurizing the pipeline. Mechanisms are known which use a completely pressurized container to hold a valve or other pipeline control mechanism under pressure during service. Such a container cannot be completely depressurized to be cleaned out because the system is fully pressurized at all times.

Other methods are known for inserting a replacement valve into a pipeline without having to depressurize the line, for example that disclosed in U.S. Pat. No. 6,041,806. A method of this type is disclosed in US Patent Publication No. 2023/0041200, in which a replacement valve assembly is positioned between cut ends of a section of pipe, and when a gate isolator is moved into the body of the valve assembly, internal seals from the replacement valve are pushed into the bores of the ends of the existing cut pipe. Such previous methods and devices, however, had no way to lock the internal seals away from a gate valve isolator once the insertion service was complete, or to retract them if desired.

### SUMMARY

The present invention comprises a replacement valve assembly 10 for a pipe. The replacement valve has (1) a valve body 30, (2) a right side 16 cut-covering assembly 20, and (3) left side 16 cut-covering assembly 20, with the left and right side cut-covering assemblies being adapted to join and seal respective ends of a cut pipe, such as in a pipeline. The valve body 30 has a right side 16, a left side 18, and a vertical axis 305, and further includes:
(a) a right side 16 cylinder 32 having a cylinder wall 325 and having a proximal end 321 with a proximal opening 326 and a distal end 322 with a distal opening 327;
(b) a left side 18 cylinder 32 having a cylinder wall 325 and having a proximal end 321 with a proximal opening 326 and a distal end 322 with a distal opening 327; and
(c) a central chamber 306 between the proximal end of the right side cylinder and the proximal end of the left side cylinder for receiving a vertically movable valve 31.

The central chamber, the right side cylinder, and the left side cylinder of the valve body are disposed along a longitudinal axis and are in fluid communication so as to form a fluid passage between the proximal opening of the right side cylinder and the proximal opening of the left side cylinder.

The cylinder wall of at least one of the right side cylinder or the left side cylinder of the valve body includes at least one return spring assembly 40 which has a return spring 41 positioned in a spring chamber 45 in the cylinder wall 205. The return spring assembly further comprising a barrel 42 secured to the cylinder wall 205 which extends laterally through the spring chamber 45 and contacts a proximal end of the return spring.

The right side cut-covering assembly 20 of the replacement valve assembly is positioned in an interior of the right side cylinder and includes:
(a) a right side cut-covering conduit 210 having an exterior surface 214, an interior surface 213, a proximal end 211 adjacent the central chamber, a distal end 212, and a medial portion 219 between the proximal end and the distal end;
(b) a right side elastomeric seal 23 having an exterior surface 232 and an interior surface 231, wherein the exterior surface of the right side elastomeric seal contacts an interior surface of the right side cylinder and the interior surface of the right side elastomeric seal contacts the exterior surface of the right side cut-covering conduit; and
(c) a proximal sloped surface 22 formed in or mechanically connected to the proximal side of the right side cut-covering conduit, wherein the sloped surface extends at an acute angle with respect to the vertical axis of the valve body and extends into the central chamber.

The left side 18 cut-covering assembly 20 of the replacement valve assembly is positioned in an interior of the left side cylinder and includes:
(a) a left side cut-covering conduit having an exterior surface, an interior surface, a proximal end adjacent the central chamber, a distal end, and a proximal portion between the proximal end and the distal end;
(b) a left side elastomeric seal having an exterior surface and an interior surface, wherein the exterior surface of the left side elastomeric seal contacts an interior surface of the left side cylinder and the interior surface of the left side elastomeric seal contacts the exterior surface of the left side cut-covering conduit; and
(c) a proximal sloped surface formed in or mechanically connected to the proximal side of the left side cut-covering conduit, wherein the sloped surface extends at an acute angle with respect to the vertical axis of the valve body and extends into the central chamber.

When the movable valve 31 is moved vertically between a first position and a second position, a first side of the valve contacts the right side sloped surface of the right side cut-covering assembly and urges the distal end of the cut-covering assembly out of the distal opening of the right side cylinder. A second side of the valve contacts the left side sloped surface of the left side cut-covering assembly and simultaneously urges the distal end of the cut-covering assembly out of the distal opening of the left side cylinder. At the same time, the barrel urges the proximal end of the return spring distally, thereby compressing the return spring.

Another aspect of the present invention is a method for replacing a valve in a pipe which makes use of the pipe's interior fluid pressure. Fluid pipelines may conduct water or other fluids at high pressure, for example 80 pounds of pressure per square inch water or more. For an 8 inch cylinder that with 200 square inches of surface area, there may be 16,000 pounds of force pressing against the inner wall of a replacement valve conduit. In this method, a valve housing is placed in fluid-tight engagement with a section of pipe, and the pipe is then cut, thereby creating a right side opening and a left side opening in the pipe. A replacement valve assembly is then advanced into the housing. The replacement valve has a cut-covering assembly disposed within each valve pipe-end, with each cut-covering assembly comprising a cylindrical, elastomeric seal 23 and a conduit within the seal. The valve and pipe-end assembly are placed into alignment with the right side opening and the left side opening of the pipe, and a linear moving valve is then placed into the housing and doing so thereby urges the elastomeric seal 23 and the conduit of each cut-covering assembly into respective pipe openings. Following this, pressure around the housing is released, and the interior fluid pressure of the pipeline urges the elastomeric seal 23 of each cut-covering assembly against the interior surface of a respective pipe and thereby seals the cut-covering assembly.

The present assembly and method solves a few major issues. The present method uses downward linear movement of a gate valve's isolator when operated by hand or power toward a closed position. The downward movement causes the gate's isolator to move against opposing cut-covering cylinders that include sloped ends. This engagement by the isolator as it continues to travel against both cut-covering cylinder sloped ends pushes the cut-covering assemblies outside of a housed position from within the gate valve pipe ends which are attached to opposite sides of the valve. Within the valve pipe end walls are tension springs that become energized in tension by the movement of cut-covering assemblies as the continued downward force is applied to the sloped ends.

The gate's isolator movement pushes or wedges against the sloped cut-covering cylinder ends forcing the cut-covering assemblies to enter into the existing pipeline. The movement of the cut-covering assembly compresses tension springs in the valve pipe end walls. If the gate valve isolator movement is reversed or retracted, the isolator force is systematically removed as it travels up the sloped ends and the tension that was produced causes the cut-covering assembly to follow the springs' movement returning the cut-covering assembly back within the gate valve pipe ends, to its original housed position. Once the gate valve pipe ends align with the existing pipeline ends, the gate valve isolator presses against the sloped cut-covering cylinder shapes or optional provided bent rods to move the opposing cut-covering assemblies out of their housed position within the valves pipe ends into exposed cut pipeline ends allowing a sealing position on both sides of the inserted gate valve by covering entire gaps created by the cutting the pipeline for inserting the valve. These seals temporarily cover cuts made in the pipeline in fluid-tight arrangement between the new valve pipe ends and the existing pipeline ends until permanent external seals can be installed to join the existing pipeline ends with the valve pipe ends. This process can be used on most known pipe types to install many known gate valves.

This invention provides a system to retract the cut-covering assemblies by use of housed attachments installed within the walls of the valve pipe ends. This assembly provides a protected clear path for fluid to pass and performs retraction of the cut-covering cylinders without interference to the path of the pipeline's fluid, and also protects against any solids found in raw sewage that could attach to exposed springs by flowing debris. In addition, the retraction apparatus of the cut-covering assembly is not attached to the valve and operates independently from the valve body, so it can allow a standard valve warranty to exist.

Not being able to retract the cut-covering assemblies when using prior replacement valve systems may be a concern during a valve's insertion process. Retraction of the cut-covering assembly allows the reversal of a valve's insertion procedure if a problem arises during installation. In addition, while depressurization of water from outside of the valve and valve pipe ends can be used to move or set the seals of this system in position over a cut gap, this invention further provides a mechanical means to increase the diameter of the cut-covering assembly while entering or after entering existing pipeline ends in order to hold the seals closer to intended locations in need of sealing, so sealing by depressurization is more effective. Entering the existing pipeline ends with a smaller outside diameter than an existing pipeline inside diameter can help offset misalignment or offset between the valve pipe end and the existing pipeline end that may occur and reduce interference of internal corrosion that may be encountered that would hinder forward movement of the cut-covering assembly. Misalignment or any obstructions such as heavy corrosion encountered by the cut-covering assemblies while entering an existing pipeline can restrict the cut-covering assembly movement or expansion. Thus, this invention provides a cut-covering assembly that can be held at a reduced diameter, smaller than the existing pipeline inside diameter, and as the cut-covering assembly advances into the pipeline diameter the cut-covering assembly expands larger to meet the inside diameter of the existing pipeline to aid in sealing and place the seal close to the area needed to seal without rubbing the existing pipeline ends inside diameter as it travels.

The present mechanism preferably includes at least one diameter guide pin or member attached to the valve pipe end. The diameter guide pin passes through at least one elongated slotted opening through the cut-covering cylinder assembly. The diameter guide pin passes through one or more angled slots installed through the cut-covering cylinder to spread the cut-covering cylinder when being advanced. When the cut-covering cylinder is advanced toward the direction to exit the valve pipe ends the diameter guide pin or pins force the cut-covering cylinder to move in an outward direction expanding the cut-covering cylinder diameter to meet the existing pipeline inside diameter. When the movement is reversed in a retracting direction, the cut-covering cylinder preferably reduces in diameter as it retracts back into the valve pipe ends. Diameter guide pins being anchored to the valve pipe end walls and through the angled and slotted cut-covering cylinder encourage movement that forces expansion of the cut-covering cylinder in diameter when the slotted cut-covering cylinder is forced out of the pipe wall and retraction of the cut-covering cylinder diameter when the slotted cut-covering cylinder is moved back into a housed position within the valve pipe ends.

Furthermore, this invention also provides an automatic assembly that can permanently lock or restrain the cut-covering assembly away from the gate valve isolator once insertion of the valve into a live pipeline is complete. The present method can include at least one spring-loaded plunger assembly commonly known as a spring-plunger. When the spring-plunger aligns with an opening in the cut-covering assembly it can release a spring-loaded pin into the opening to hold the cut-covering assembly in a selected position. The locking of the cut-covering assembly can hold the sloped ends of the cut covering cylinder away from the valves isolator once the insertion process is complete. Without providing this locking mechanism, after the valve insertion is complete, the return tension springs could continue to return the cut-covering cylinder back to its original position against the isolator.

### BRIEF DESCRIPTION OF DRAWINGS

FIG. 1 is a side elevation view of a gate valve with mechanically attached valve pipe ends installed on both ends. Each valve pipe end houses cut-covering sealing assemblies. Return spring assembly shown within valve pipe end wall. The illustration shows the valves gate isolator resting against the cut-covering assembly sloped side. Diameter guide pins are anchored into the valve pipe end walls and protrude through the angled slots installed on the cut-covering cylinder to allow expansion and retraction of cut-covering cylinder. The spring-plunger assembly is shown attached to both valve pipe ends to lock and restrain the cut-covering cylinder away from the gate once the insertion of the valve is complete.

FIG. 2 is a side elevation view of a gate valve with a mechanically attached valve pipe end. This embodiment shows a tapered gland rubber and a rigid gland used with bolts to join the valve pipe end with the valve body. This valve pipe end is shown to hold the cut-covering sealing assembly. A similar valve pipe end housing a cut-covering sealing assembly is attached to the opposing side of the gate valve but not shown in this figure.

The illustration shows the valve's gate isolator in the open position residing close to, but not moving, the cut-covering cylinder sloped ends. The return spring assembly installed within the wall of the valve pipe end is not shown compressing the tension spring, keeping the cut-covering cylinder housed within valve pipe end for a clear insertion of the valve assembly into a removed section of existing pipeline. Diameter guide pins are shown anchored into the valve pipe end walls and protrude through angled slots provided within the cut-covering cylinder.

A spring-plunger assembly is shown installed in the valve pipe end to be riding along the surface of the cut-covering cylinder but not engaging into a provided pocket on the cut-covering cylinder shown that can provide locking of the cut-covering assembly if desired.

FIG. 3 is a side elevation view of a gate valve with a mechanically attached valve pipe end. In this embodiment, a tapered gland rubber and a rigid gland are used with bolts to join the valve pipe end with the valve body. The valve pipe end is shown to hold a cut-covering sealing assembly. The illustration shows the gate valve isolator closing movement with a downward arrow, with the isolator abutting and moving the cut-covering assembly by the shape of its sloped ends. This movement provides a pushing motion to the cut-covering assembly, which is shown partially moved out of the valve pipe end.

The return spring assembly installed within the wall of the valve pipe end is shown to be compressed by cut-covering assembly outward movement. The return spring assembly compression enables a return action of the cut-covering assembly if the need is required. The forward or outward movement moves the cut-covering assembly to cover a gap between the inserted valve pipe ends and existing pipeline ends as shown in FIG. 9.

Diameter guide pins, which are shown to be anchored to the wall of the valve's pipe end in FIG. 6, protrude through angled slots provided within the cut-covering cylinder. The slots are disposed in the split tube at an acute angle with respect to the split portion of the tube, so that outward movement of the split tube forces the angled slot to move along the anchored pin, thereby urging the distal end of the split tube to have a larger outside diameter when the cut-covering assembly is extended past the valve pipe ends. The spring-loaded plunger is shown installed in the valve pipe end and engaged into a pocket shown on the cut-covering assembly that performs locking.

FIG. 4 is a side view of valve pipe end showing the return spring pocket holding a return tension spring with a binding barrel shown passing through the slot of a return tension spring pocket. The return tension spring is shown abutting the binding barrel. This arrangement allows the binding barrel, when moved down the slot, to compress the return tension spring.

FIG. 5 is a side view of the valve pipe end showing a return spring assembly in a relaxed non-tensioned position, in this position the return tension spring holds the cut-covering cylinder in a housed position within the valve pipe end for a gate valves insertion. The spring-loaded retaining plunger is shown installed in the valve pipe end and can ride along the surface of the cut-covering cylinder not engaged into an opening in the cut-covering cylinder until desired.

FIG. 5A is a side view of return spring assembly installed within the wall of the valve pipe end shown to be compressed by a binding barrel connected to the cut-covering assembly traveling outward from the valve pipe end. Spring compression enables a return action of the cut-covering assembly as needed prior to the retaining plunger being set.

Here the retaining plunger mounted in the valve pipe end is shown to have moved into alignment with an opening in the cut-covering assembly. This alignment allows the spring-loaded retaining plunger to pass through the opening in the cut-covering assembly and lock the valve pipe end with the cut-covering assembly permanently to keep the gate isolator away from the cut-covering cylinder.

FIG. 6

Depicts an end view of the cut-covering assembly that presents how return spring assemblies can be installed, the return spring assembly within the valve pipe end wall can provide a clear pathway for fluid movement within the pipeline and past the valve and valve pipe ends while the return spring assemblies perform their function from outside of the fluids path. At least one or multiple return spring assemblies with shown attachments to cut-covering cylinders can be used to perform this task.

The cut-covering assembly in this view allows an overlap of the cut-covering cylinder if desired. This overlap contributes to the expansion and retraction of the cut-covering assembly and works with at least one guide pin through at least one angled slot in the cut-covering cylinder to reduce and expand the cut-covering cylinder's diameter when advanced and reduction of the cut-covering cylinder diameter if returned back into the valve pipe end.

FIG. 6A is a sectional view of valve pipe end wall, detailing how the return tension spring is inserted within the return spring pocket, and how the binding barrel can cross over the return tension spring in communication within the pocket, also indicates how the cut-covering cylinder can be attached to the binding barrel by at least one threaded screw, this combination provides movement from the cut-covering cylinder to the binding barrel and compression of the return tension spring.

FIG. 7

Is a side elevation view showing how the isolator of a valve can move both cut-covering assemblies at the same time. This view shows cut-covering assemblies housed within both valve pipe ends, ready for insertion into a cut and removed section of the pipeline. The isolator is not shown to be moving the cut-covering cylinder sloped ends. The cut-covering cylinder diameter is smaller when retracted within the valve pipe ends. The return spring assemblies are not shown for clarity but shown in FIG. 8.

FIG. 8

Is a side a side elevation of FIG. 3, showing how the isolator of the valve is moving both cut-covering assemblies at the same time. This view shows cut-covering assembly inside valve pipe ends and a portion moved outside of the valve pipe ends by downward lateral movement by the gate valve isolator.

The gate isolator is shown moving in contact with the cut-covering assembly sloped ends, and the cut-covering assemblies are shown moved partially outside of valve pipe ends. The cut-covering assembly increases in diameter when advanced outside of the valve pipe ends. Return spring assemblies in both valve pipe ends are being compressed in tension and both retaining plungers are shown to have been selectively released by allowing the cut-covering cylinders to travel a point where they are locked with the valve pipe ends away from the isolator.

FIG. 9 is a side elevation of FIG. 8, showing how the cut-covering assemblies are moved out of valve pipe ends by the valve isolator movement and have entered the cut ends of the existing pipeline. The cut-covering preferably includes flexible material that covers the cut gap to seal in fluid tight arrangement, between the valve pipe ends and the existing pipeline ends.

The cut-covering assemblies are clearly outside of the valve pipe ends to a predetermined location, so the cut-covering flexible seal covers and seals the full area of the valve pipe end inside diameter, included is the entire gap left by a pipe cutting procedure and the full inside diameter of the existing pipeline ends shown, forming a fluid tight connection between the valve pipe ends and the existing pipeline ends. The cut-covering cylinder is shown with a split cylinder (on the left side of FIGS. 8 and 9) and a non-split cylinder on the right side). Different combinations of split and no-split cylinders can be used for the cut-covering assembly for various reasons and needs.

FIG. 10 is a side view of a gate valves isolator in relation to opposing sloped ends of the cut-covering assembly. A protective covering may be installed to protect the isolator from a sharp edge of the rigid material as lineal force is applied. Many known coverings can be used to perform this protection.

FIG. 11 is a side view showing opposing sloped ends on the cut-covering assemblies that can include at least one wheel to ride along the isolator, helping to move the cut-covering assembly in an outward direction. Multiple wheels can be incorporated to complete movement and travel of the isolator along the sloped ends.

| Component | Reference Number |
|---|---|
| 10 | Valve Pipe-Assembly (replacement valve) |
| 11 | Valve Pipe (cylinder) distal end |
| 13 | Pipe-end to Valve flange/M/J Gland |
| 14 | Flange to Valve bolts |
| 15 | Flange or M/J to Valve Gasket |
| 16 | Right Side |
| 18 | Left Side |
| 20 | Cut-covering Assembly |
| 210 | Cut-covering conduit |
| 211 | Cut-covering conduit proximal end |
| 212 | Cut-covering conduit distal end |
| 213 | Cut-covering conduit interior surface |
| 214 | Cut-covering conduit exterior surface |
| 216 | Cut-covering conduit proximal opening |
| 217 | Cut-covering conduit distal opening |
| 219 | Cut-covering conduit medial portion |
| 20 A | Split Cut-covering Cylinder |
| 20 B | Non-split Cut-covering Cylinder |
| 21 | Cut-covering Assembly partially out valve pipe-end |
| 22 | Cut-covering Cylinder sloped surface/end |
| 22A | Cut-covering Cylinder slope protector |
| 22B | Cut-covering Cylinder Wheeled end |
| 23 | Cut-covering flexible seal |
| 231 | Cut-covering seal interior surface |
| 232 | Cut-covering seal exterior surface |
| 25 | Cut-covering Cylinder - Reduced Diameter |
| 25A | Cut-covering Cylinder - Expanded Diameter |
| 27 | Cut-covering Cylinder Overlap |
| 28 | Cut-covering Cylinder Reinforcement |
| 30 | Gate Valve body |
| 305 | Gate Valve body vertical axis |
| 31 | Gate valve isolator |
| 32 | Gate valve cylinder |
| 321 | Gate valve cylinder proximal end |
| 322 | Gate valve cylinder distal end |
| 325 | Gate valve cylinder wall |
| 326 | Gate valve cylinder proximal end opening |
| 327 | Gate valve cylinder distal end opening |
| 33 | Gate valve operator |
| 34 | Isolator activator Stem |
| 36 | Gate valve Bonnet |
| 40 | Return spring Assembly |
| 41 | Return Tension Spring |
| 411 | Return spring proximal end |
| 412 | Return spring distal end |
| 42 | Binding Barrel |
| 42A | Binding Barrel Threaded Screw |
| 43 | Binding Barrel slot |
| 45 | Return spring Pocket (spring chamber) |
| 50 | Diameter expansion/reduction assembly (diameter |
| | changing assembly) |
| 51 | Diameter Guide Pin |
| 52 | Diameter Guide Slot |
| 53 | Cylinder pivoting rivet |
| 54 | Cut-covering Cylinder O.D. reduction |
| 60 | Retaining plunger Assembly |
| 61 | Retaining plunger |
| 62 | Cylinder Retaining Plunger opening |
| 70 | Existing pipeline-ends |
| 71 | Cut Gap |
| 80 | Permanent Exterior Coupling |

### DETAILED DESCRIPTION

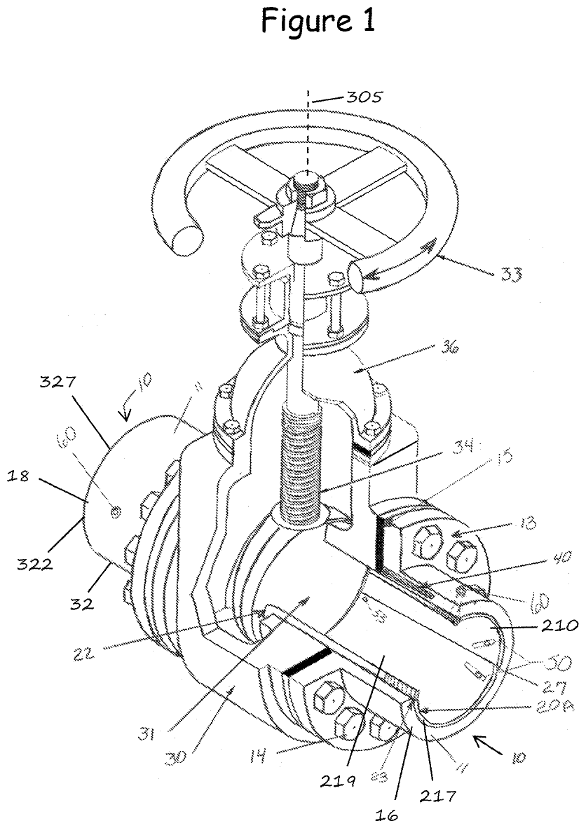

FIG. 1 illustrates a return spring assembly 40 that operates to expand and retract cut-covering assembly 20 from within the valve pipe end 11 wall to provide full flow of a pipeline product. The cut-covering assembly can include a split tube shown as 20A that expands by the diameter expansion/reduction assembly 50, but which initially forms a smaller outer diameter at a distal end to move into the inside diameter of existing pipeline ends 70. As the split cut-covering cylinder 20A advances into existing pipeline ends 70 (FIG. 9), the split cut-covering cylinder 20A diameter increases to fit and meet with a larger inner diameter of pipeline ends 70. A retaining plunger assembly 60 can be provided to lock the cut-covering assembly 20 into a position to keep it permanently separated from the gate valve 30 isolator 31 after insertion of the valve is performed.

Valve pipe ends 11 with cut-covering assemblies 20 are housed within valve pipe-assembly 10, being attached to opposing sides of a conventional gate valve 30. Various known connection means can attach valve pipe-assembly 10 to gate valve 30, for example a flange, mechanical joint 13, or other known connections can be used with intermediate seal or gasket 15 to obtain a fluid-tight arrangement.

Valve pipe-assembly 10 with valve pipe ends 11 are shown to house cut-covering assemblies 20. The cut-covering assembly 20 can include at least one flexible seal 23 that can be attached to cut-covering cylinder 20. The cut-covering assembly 20 can be advanced or moved to cover cut gap 71 shown in FIG. 9, between the installed gate valve 30 valve pipe-assembly 10 and opposing existing pipeline ends 70. The cut-covering flexible seal 23 is made up of a pliable surface that can cover a cut gap 71 in fluid-tight arrangement, but cut-covering assembly 20 can include a fairly rigid material. The cut-covering assembly 20 shown is here preferably a metal cut-covering cylinder 20, but many materials are candidates for the split cut-covering cylinder 20A and non-split cut-covering cylinder 20B or a combination of both 20A and 20B to provide the cut-covering cylinder.

In this embodiment, gate valve 30 with valve pipe end 11 are generally used in conjunction to install a gate valve 30 into live pressurized pipeline systems 70 as seen in FIG. 9. The insertion process is performed without being able to view the process, since pipeline 70 remains fully pressurized. If an error was to occur during insertion of the valve, reversing the insertion process is important to allow removal of a semi-inserted gate valve 30. To release and remove a gate valve 30, the cut-covering assemblies 20 will need to be retracted from existing pipeline ends 70 (shown in FIG. 9) back into a housed position within valve pipe ends 11, seen in FIG. 7. This position can allow unrestricted removal of gate valve 30 from its installed or semi-installed position. Being able to remove gate valve 30 if the insertion process is defective is important because the only way to correct the issue would be to shut off an entire pressurized pipeline system to allow removal if valve 30.

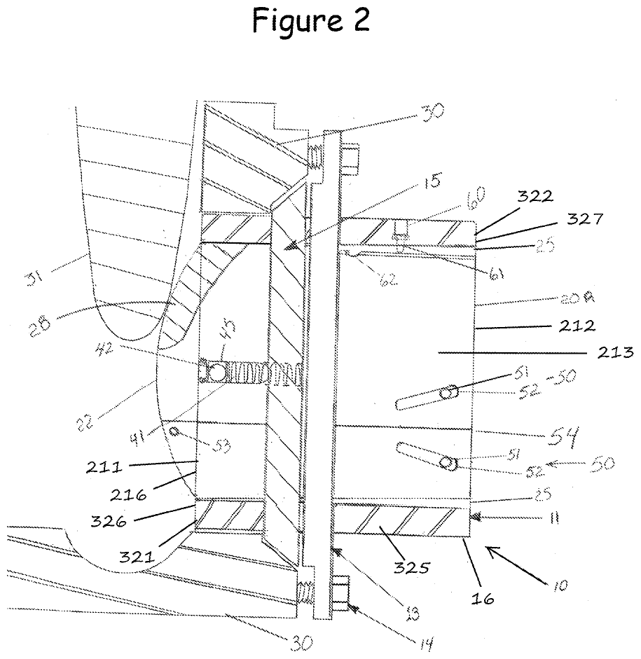

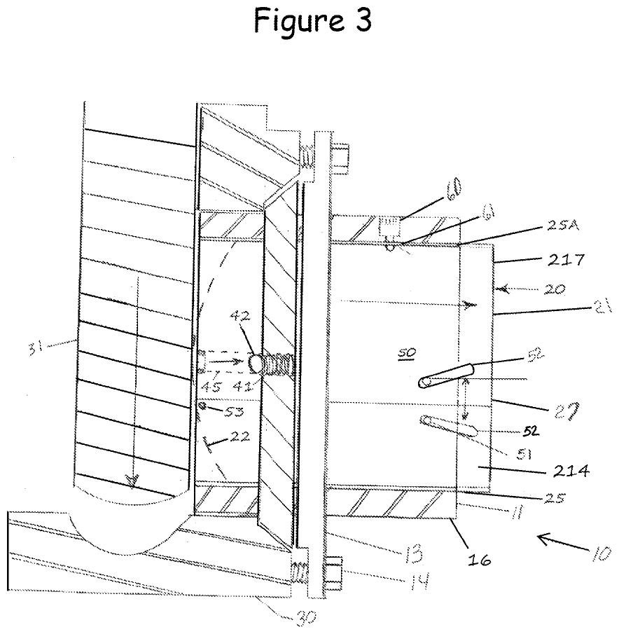

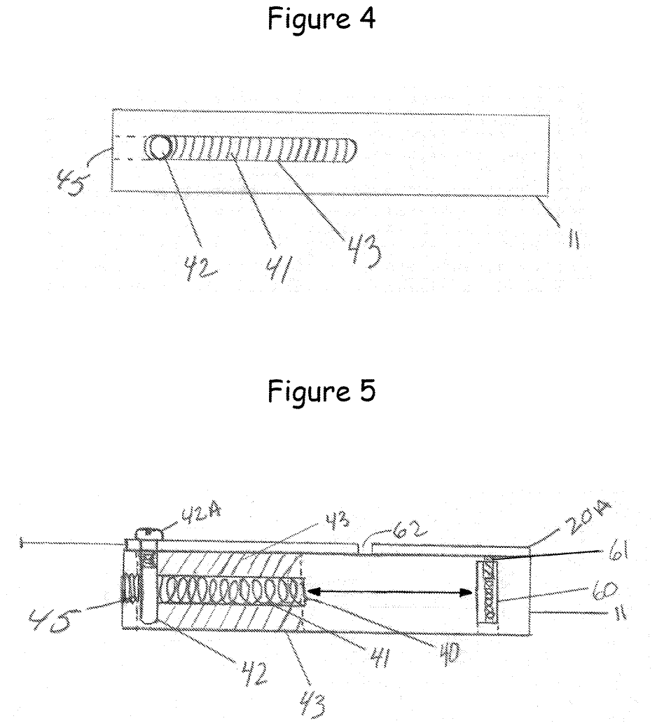

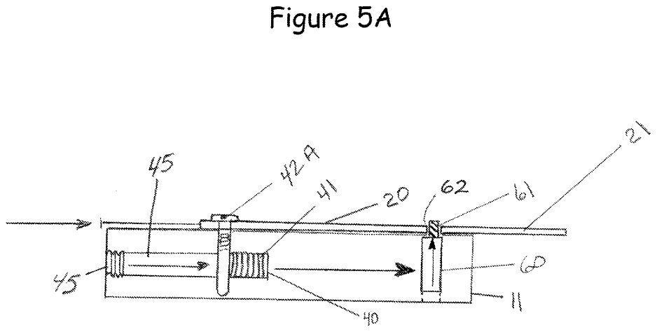

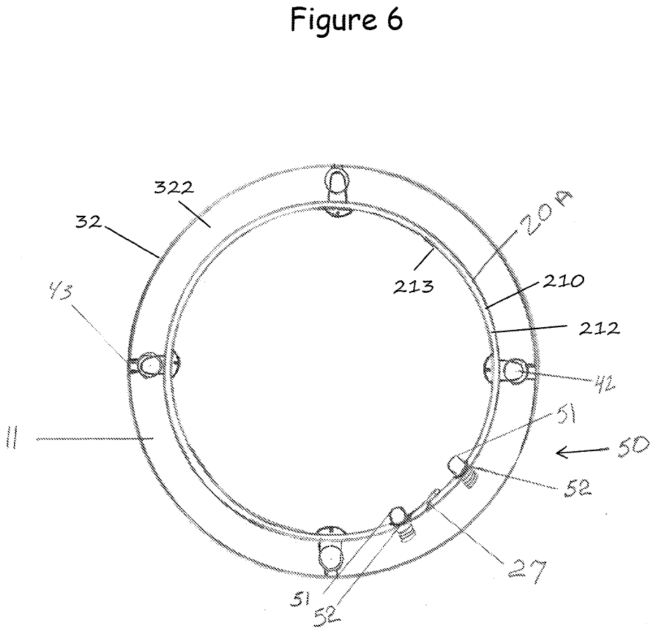

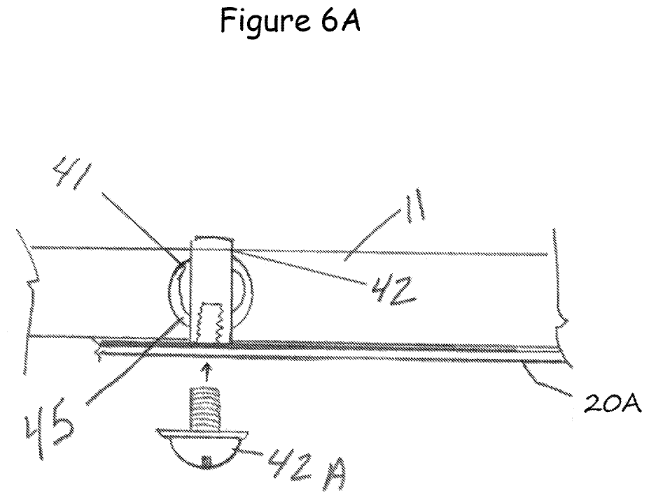

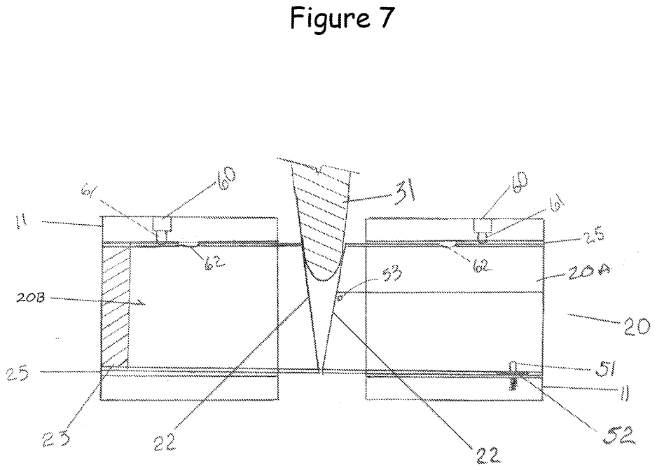

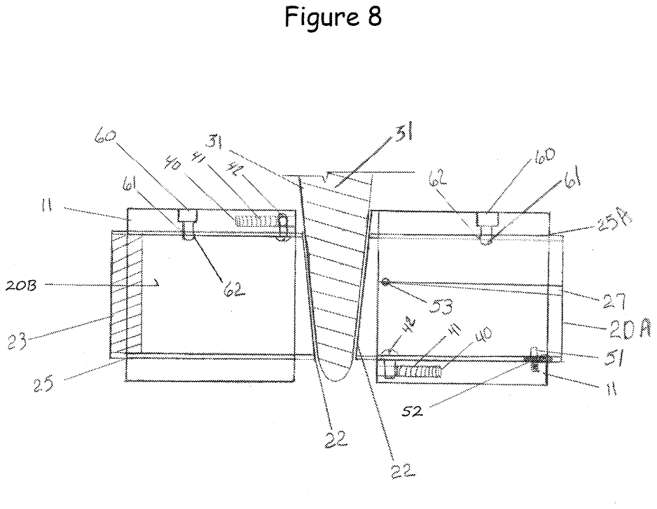

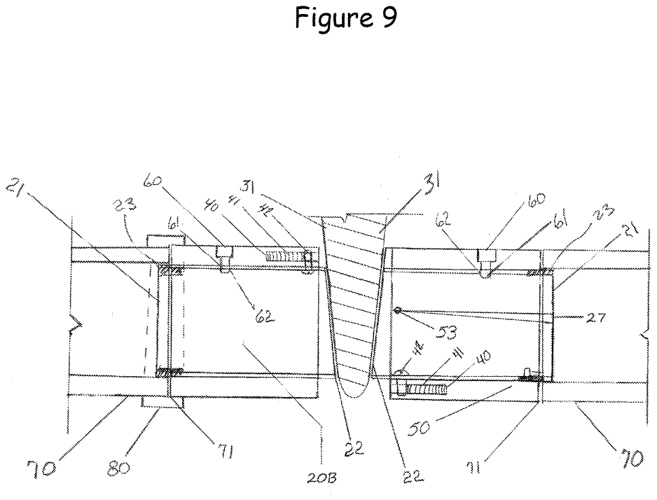

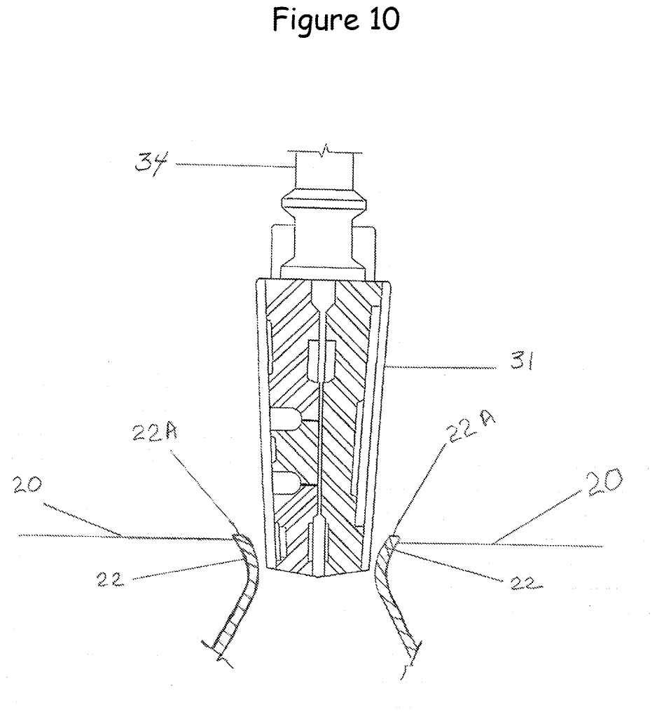

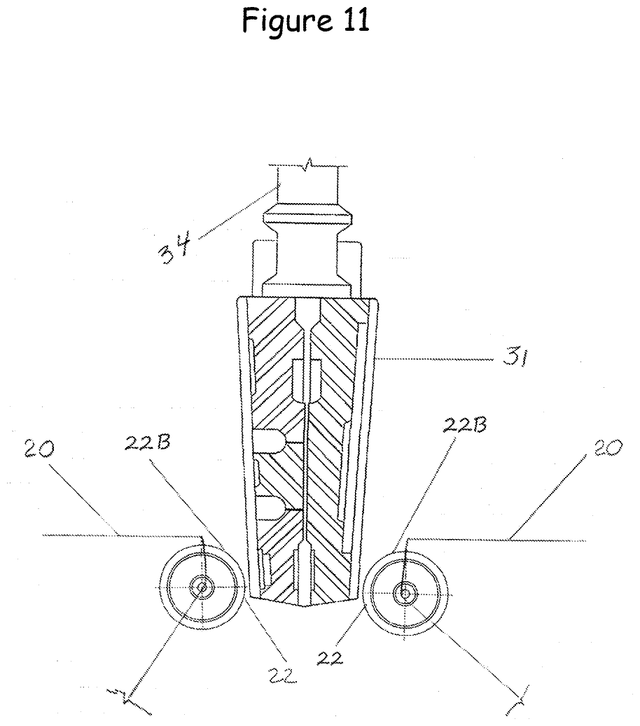

FIG. 2 is a side view of valve pipe-assembly 10, detailing attachment means made by mechanical joint gland 13 compressing a tapered mechanical joint rubber gasket 15 by tightening bolts 14 to provide compression to seal in fluid tight fashion and restrain the valve pipe ends 11 with gate valve 30. The gate valve isolator 31 is in a semi-open position but not in moving into engagement with the sloped cut-covering cylinder ends 22.

The cut-covering cylinder 20A and 20B of cut-covering assembly 20 can be made of known rigid materials including carbon steel, stainless steel, composite or various plastics. Various shapes, such as round, square and other shaped structures, can be added or attached to the cut-covering 20 assembly reinforcement 28 (FIG. 2) to aid in the strengthening of cut-covering cylinder 20 and help withstand different isolator 31 lineal forces that may be encountered to sloped end 22.

Cut-covering cylinder 20A and 20B must be rigid enough to push and pull the cut covering assembly 20 including moving a flexible seal 23 as shown in FIGS. 7-8 past valve pipe ends 11 into existing pipeline ends 70 (FIG. 9). Cut-covering flexible seal 23 is not shown in all drawings for clarity of drawing details. Housed within valve pipe end 11, FIG. 2 shows a split cut-covering cylinder 20A having a reduced diameter 25 making valve 30 and attached valve pipe ends 11 ready for insertion.

Expansion/reduction assembly (diameter changing assembly) 50 can be installed to perform an increase and a reduction of diameter of the cut-covering assembly 20. Expansion/reduction assembly 50, shown here in FIG. 2, provides cut-covering assembly 20 with the means to reduce its diameter 25. Cut-covering assembly 20 being retracted within valve pipe ends 11 uses two anchor pins as shown installed in distal valve pipe end 11 that pass through at least one angled guide slot 52 of split cut-covering cylinder 20A. This arrangement results in a reduction in diameter of the distal opening of the cut-covering cylinder 201 by inward movement of the cut-covering cylinder angled slots, as the slots travel with and follow the anchored pins against and follow the anchored pins. Various diameters can be obtained by changing the angle of the slots and the position of the diameter pins. Multiple pins and slots can be imagined in performing this function. The purpose of the reduced diameter 25 while entering the existing pipeline-end 70 FIG. 9 is to aid in clearing any slight mis alignment between the valve 30 valve pipe ends 11 and existing pipeline ends 70, in the event that corrosion in the pipe is present will help in continuing forward movement 21 of cut-covering assembly 20.

When cut-covering assembly 20 is moved out by isolator 31, with a split cut-covering assembly 20A it is designed to increase in diameter as it travels, the expanded diameter is shown as 25A in FIG. 3. In the event that the cut-covering assembly 20 needs to be retracted, the expansion/reduction assembly 50 will perform a reduction in diameter of split cut-covering cylinder 20A as it returns back into valve pipe ends 11, this reduction in diameter is shown as 25 FIG. 2 and simultaneous reduction in diameter 25 is shown in FIG. 7. The expansion/reduction assembly 50 is shown to have at least one diameter guide slot 52 that can be provided and in split cut-covering cylinder 20A, two diameter guide slots 52 are shown in this detail of FIG. 2 and the diameter guide slots 52 can pass through openings in the cut-covering cylinder 20, this cut-covering cylinder or a portion of cut-covering cylinder is shown to be split 20A, the diameter guide slots 52 are provided with various angles or shapes to achieve movement of the cut-covering cylinder 20 when moved.

Return spring assembly 40 shown in FIGS. 2-5 can be installed to operate from within the valve pipe end wall 11, allowing for clear passage of pipeline fluid unrestricted through the valve 30 and valve pipe ends 11. One return spring assembly 40 is shown but multiple may be preferred to provide retraction of cut-covering assembly 20. This development provides the means to retract cut-covering assembly 20 from pipeline ends 70 back into a housed position completely within valve pipe ends 11. Retraction allows an inserted valve 30 with valve pipe ends 11 to be removed from a sandwiched position between existing pipeline ends 70, shown in FIG. 9 in the event that a problem would arise during the gate valves insertion.

FIG. 3 is a side view of a portion of valve pipe assembly 10. The gate valve isolator 31 is moving toward a semi-closed position, as shown by its arrow, and is in engagement with the sloped cut-covering cylinder ends 22 of cut-covering assembly 20. Cut-covering assembly 20 is shown moving out of valve pipe end 11 and providing an expanded diameter by expansion/reduction assembly 50 shown increasing or expanding its diameter shown as 25A. Cut-covering assembly 20 being moved out of valve pipe ends 11 uses two anchor pins as shown installed in valve pipe end 11 that pass through at least one angled guide slot 52 of split cut-covering cylinder 20A. This arrangement performs an increased diameter by outward movement of the cut-covering cylinder angled slots, as the slots travel with and follow the anchored pins. Various diameters can be obtained by changing the angle of the slots and the position of the diameter pins. Multiple pins and slots can be imagined in performing this function.

Cut-covering assembly 20 can include flexible seal 23 (seen in FIGS. 7 and 9) to cover cut gap 71 to join gate valve 30 with existing pipeline ends 70 in fluid tight arrangement. Split cut-covering cylinder 20A is provided with a cut-covering cylinder overlap 27 that allows a diameter to be reduced and expanded in diameter while overlap 27 sliding movement supports flexible seal 23 from extruding through cut gap 71 when fluid pressure is applied. FIGS. 7, 8 and 9 illustrate the use of an optional non-expanding and non-over lapping cut-covering cylinder 20B which can be used for certain applications and in a combination with split cut-covering cylinder 20A for various cut-cylinder sealing and applications.

Return spring assembly 40, shown in FIGS. 1-8 operates from within valve pipe end wall 11, keeping return tension springs 41 out of a pipeline's flow path and providing a clear passage of a pipeline's fluid so that it can move unrestricted.

FIG. 3 shows cut-covering assembly 20 to be advanced outside of valve pipe end 11, shown as detail 21, this movement of cut-covering cylinder 20 has created compression of the return tension spring 41 to perform retraction if the need is required.

FIG. 4 is a sectional view of valve pipe end wall 11 showing return spring assembly 40, at least one return spring pocket 45 is provided to accept the return tension spring 41, in position with binding barrel 42 as a backstop for return tension spring 41, cut-covering assembly 20 in FIG. 5 attached with binding barrel 42 by use of at least one binding barrel threaded screw 42A, shown in detail in FIGS. 5 and 6A.

Return spring pocket 45 installed within valve pipe end 11 has opposing elongated openings shown as binding barrel slot 43. The slots 43 are narrow enough to keep return tension spring 41 retained but allows binding barrel 42 to move freely within the slots during return tension spring 41 compression, as seen in FIG. 5A, by cut-covering assembly 20 outward movement as seen at 21 in FIG. 5A.

FIG. 5 is a sectional view of valve pipe end 11 presenting binding barrel 42 being attached to cut-covering assembly 20 by at least one binding barrel threaded screw 42A, this attachment allows binding barrel 42 to move within binding barrel slot 43 back and forth as needed. Lines shown coming from return spring pocket 45 portray binding barrel slot 43. Cut-covering assembly 20 is shown to be in a retracted position leaving return tension spring 41 in a relaxed state with no compression, with binding barrel slots 43 providing the binding barrel 42 free movement during compression and non-compression by movement of the cut-covering assembly 20.

In addition, shown installed within valve pipe end 11 is at least one retaining plunger 61, riding on cut-covering assembly 20 in an unreleased state, the cut-covering cylinder provides an opening 62 that is not shown to be in alignment with the retaining plunger 61 during this stage.

FIG. 5A is a sectional view of valve pipe end 11 with at least one retaining plunger assembly 60 installed in valve pipe end wall 11, when the retaining plunger assembly 60 is compressed retaining plunger 61 rides along cut-covering assembly 20 in an unreleased state. As shown, when the retaining plunger 61 reaches alignment with designated cut-covering cylinder opening 62 installed in cut-covering assembly 20, the alignment allows retaining plunger 61 spring loader plunger to pass through cut-covering cylinder opening 62 to restrain cut-covering assembly 20 into a position keeping sloped cut-covering cylinders 22 away from valve isolator 31.

FIG. 6 showing a front view detailing return spring assemblies 40 installed within valve pipe end wall 11. This method allows unobstructed fluid movement to pass through valves pipe ends 11 while providing protected return spring assemblies 40.

At least one return spring pocket 45 is provided to house at least one return tension spring 41 seen in FIG. 6A. The split cut-covering cylinder 20A is installed and housed inside valve pipe end 11, at least one binding barrel 42 is attached to split cut-covering cylinder 20A by binding barrel threaded screw 42A. In this FIG. 6, cut-covering cylinder 210 is shown to be split and provides a cut-covering cylinder overlap 27 of cut-covering cylinder. The cut-covering cylinder shows at least one diameter guide pin 51 anchored into valve pipe end 11 wall that passes through the diameter guide slot split cut-covering cylinder 20A.

FIG. 6A is a sectional view of valve pipe end 11 wall showing return spring pocket 45 accepting tension spring 41, with binding barrel 42 as a backstop for return tension spring 41, split cut-covering cylinder 20A can be attached to binding barrel 42 by screw headed member 42A. Binding barrel 42 attaches to split cut-covering cylinder 20A wall and can pass back and forth in binding barrel slots 43 with movement by cut-covering cylinder 20.

FIG. 7 is a side view that details how opposing cut-covering assemblies 20 can be moved outside of pipe ends simultaneously by lineal movement of gate valve 30 isolator 31. In this drawing isolator 31 is not pushing the sloped ends of cut-covering cylinder 22, cut-covering assembly 20 is shown to be completely within valve pipe ends 11. One of cut-covering cylinder 20 diameter is shown reduced as 25, retaining plunger assembly 60 is shown on both right and left side of valve pipe ends 11, the retaining plunger 61 rides on cut-covering cylinder 20 until released through cut-covering cylinder openings 62 when alignment is achieved. The cut-covering flexible seal 23 is shown only on the left side but preferably the right side will have flexible seal 23 as well.

Right valve pipe end 11 shows a split cut-covering cylinder 20A, with expansion/reduction assembly 50 and at least one angled diameter guide slot 52 in split cut-covering cylinder 20A. The left side shows a cut-covering cylinder 20B that may not be split and may not include expansion/reduction assembly 50.

This figure portrays the gate valve 30 in an open or semi open position. The valve pipe ends 11 are housing the right side and left side cut-covering assemblies 20. With Isolator 31 not wedging or withdrawn from contact with sloped ends 22 of the cut-covering cylinder 20 the cut-covering assembly 20 is shown retracting back into a housed position within valve pipe ends 11.

As seen in FIG. 2 when valve 30 isolator 31 is not engaged with sloped ends 22 or when isolator 31 is retracted by operator 33, releasing of pushing movement against the sloped ends 22 releases the tension springs to extend to move both cut-covering assemblies 20 to return back into a housed position as seen here within opposing valve pipe ends 11.

Not shown in FIG. 7 for clarity but shown in FIG. 5 is how return spring assembly 40 resides without tension within the walls of valve pipe end 11 and is made up of at least one return spring pocket 45 that can be provided as a round shape or a required shape to hold a return tension spring 41. The return spring pocket 45 depth is calculated to allow a spring 41 to rest in relaxed position when not given tension. Return tension spring 41 fits into the pocket and is in position with binding barrel 42 that crosses over the open return spring pocket 45 to trap return tension spring 41, shown in FIGS. 2, 4, 5, and 6A binding barrel 42 provides a non-passable end for the return tension spring 41.

FIG. 8 is a side view showing details of opposing valve pipe ends 11 with cut-covering assemblies 20 moving simultaneously outward past valve pipe ends 11 by lineal force movement of gate valve 30 isolator 31. In this figure, isolator 31 has pushed the sloped ends of cut-covering cylinder 22, urging cut-covering assemblies 20A and 20B out of opposing valve pipe ends 11, split cut-covering cylinder 20A diameter is shown to be expanded 25A, cut-covering cylinder 20B moves outward by does not expand. The cut-covering flexible seal 23 is shown only on the left side but preferably the right side will also have cut-covering flexible seal 23. The right cut-covering cylinder shows a split cut-covering cylinder with diameter guide pin 51 and slot in cut-covering cylinder 52. The left side shows a cut-covering cylinder that is not split and does not expand.

Cut-covering cylinder 20A and 20B include sloped ends 22 that are shaped to meet and move in contact with gate 30 isolator 31. The lineal movement of the valve isolator 31 is moved between a first position and a second position, a first side of the isolator 31 contacts at least one slope 22 of the right side of split cut-covering cylinder 20A and urges a right side end of the cut-covering assembly 20 A out of the right side valve pipe end 11 opening, simultaneously a second side of the valve isolator 31 contacts at least one slope 22 of the left side split cut-covering cylinder 20A or non-split cut-covering cylinder 20B and urges a left side end of the left side cut-covering assembly 20B out of the left side valve pipe end 11 opening.

Operator wheel 33 (seen in FIG. 1), nut, or other known means to activate the gate valve 30 stem 34 moves the gate or isolator 31 to travel down stem 34 abutting the cut-covering cylinder slope 22. The combined shape of the gate valve isolator 31 moving against slopes 22 of cut-covering assembly 20 forces cut-covering assembly 20 outward from valve pipe ends 11 into the existing pipeline ends 70 enough to cover cut gap 71 between the gate valve 30 attached valve pipe ends 11 and existing pipeline ends 70.

Opposing cut-covering assemblies 20 are simultaneously extended partially out of valve pipe ends 11, shown as 21 in FIGS. 3, 5A and 9 by movement of gate valve 30, isolator 31. The linear movement of isolator 31 advances cut-covering assemblies 20 from the valve pipe ends 11 into open existing pipeline ends 70 seen in FIG. 9 to cover cut gap 71.

FIG. 9 is a side view detailing how cut-covering assemblies 20 are clearly outside of the valve pipe ends 11 to a predetermined location so the cut-covering flexible seal 23 covers and seals the full inside diameter of valve pipe ends 11, including the entire gap 71 left by a pipe cutting procedure seen in (attachment 1 to this application) and flexible seal 23 also covers the full inside diameter of existing pipeline ends 70. The cut-covering assembly 20 forms a fluid tight connection between the valve pipe ends 11 and the existing pipeline ends 70 to join the gate valve 30 with the existing pipeline ends 70. Once insertion is complete, permanent external couplings 80 are installed to cover cut gap 71. These permanent external couplings 80 are industry known fittings that attached and cover right valve pipe end 11 and right existing pipeline-end 70 and left valve pipe end 11 and left existing pipeline-end 70. One external coupling 80 is shown here, but a second would generally be installed to cover both gaps 71.

FIG. 10 is a side view of the gate valve 30 isolator 31, in relation to opposing sloped ends 22 of cut-covering assemblies 20, a protective covering cut-covering cylinder protector 22A can be installed over the edge of cut-covering assembly 20 to protect isolator 31 during lineal movement and sharp edges that cut-covering cylinder 20 material may present.

FIG. 11 is a side view of the gate valve isolator 31, in relation to opposing sloped ends 22 of cut-covering assemblies 20, wheeled ends 22B are presented. Wheeled ends 22B can be selectively provided to aid in smoother movement between cut-covering slope 22 and isolator 31, plus protect against damage to a rubber coated isolator 31 by cut-covering assembly 20 rigid material as lineal force is applied. Wheel 22B can provide a sloped end 22 that rides along isolator 31 to urge the cut-covering assembly 20 outward by its downward lineal force. Multiple wheels 22B can be used along the cut-covering cylinder slope 22 to complete the task.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structures, functionality, or structure and functionality in addition to or other than one or more of the aspects set forth herein.

### Definitions

As used herein, the following terms and variations thereof have the meanings given below, unless a different meaning is clearly intended by the context in which such term is used.

“Barrel” refers to a cylindrical container.

“Cut-Covering Assembly” refers to a component which is moved by a valve isolator to seal the valve to existing pipeline ends. Cut-Covering assembly is also referred to as a “split tube” and a “non-Split tube” that can provide various components to move, expand, retract, seal and lock cut-covering cylinder and are housed within pipeline ends for inserting valves into a pressurized system.

“Expansion/Reduction” and variations of the term, such as “increase”, “enlarge”, “reduce”, “retract” have their usual meanings but are not intended to exclude other additives, components, integers, variations of a diameters increase or decrease in size.

“Gate valve” refers to a control valve that either allows a fluid to flow through the valve unobstructed or stops the fluid flow. A gate valve opens by retracting a barrier (gate) out of the path of the fluid. Gate valve faces can be parallel but are commonly sloped, i.e., wedge-shaped. Gate valves can also be called “isolators” and variations of these terms, and are not intended to exclude other additives, components, integers, variations of a moving flow barrier.

“Horizontal,” refers to a plane or direction which is approximately perpendicular to a surface on which the present valve assembly is placed. “Vertical” refers to a plane or direction which is perpendicular to a horizontal plane or direction.

“Pipeline-end” and variations of the term, such as “pipeline-end wall” are not intended to exclude other additives, components, integers or steps.

“Slope” refers to a surface of a component or device which extends upwardly at an acute angle (an angle of less than) 90° with respect to a vertical axis of the component or device. Slopes include both straight and curved surfaces. A component or device having a slope can be said to be in “a raised position”, “tapered position”, or “angled position”. The “raised position” or “slope” can be made up of a wheel in some embodiments.

A “split tube” refers to a conduit having a cut along its length, such as a split metal cylinder. A split tube can be rolled in on itself, so that one cut side is rolled inside the other (i.e., so that the outer surface of one cut side faces the inner surface of the other cut side) to provide spring-type expansion of the split tube. Split tubes can be split (separated) along their entire length, or can alternatively be split from a medial portion of the conduit to one end of the conduit.

“Tension-spring” and variations of the term, such as “spring” are not intended to exclude other additives, components, integers, variations of springs or steps.

“Tube” refers to a generally tubular pipe or conduit.

The terms “above,” “below,” “between,” “upward,” “downward,” “right,” “left,” and other terms of relative position or orientation as used herein refer to a relative position or orientation of one component of the valve assembly in relation to another, or to a relative position or orientation of the valve assembly in relation to a pipeline or support surface.

The terms “a,” “an,” and “the” and similar referents used herein are to be construed to cover both the singular and the plural unless their usage in context indicates otherwise. Ranges which are described as being “between” two values include the indicated values.

1. A replacement valve for a pipe, comprising:
(1) a valve body having a right side, a left side, and a vertical axis, the valve body comprising:
(a) a right side cylinder comprising a cylinder wall and having a proximal end with a proximal opening and a distal end with a distal opening;
(b) a left side cylinder comprising a cylinder wall and having a proximal end with a proximal opening and a distal end with a distal opening; and
(c) a central chamber between the proximal end of the right side cylinder and the proximal end of the left side cylinder for receiving a vertically movable valve,
wherein the central chamber, the right side cylinder, and the left side cylinder are disposed along a longitudinal axis and are in fluid communication so as to form a fluid passage between the proximal opening of the right side cylinder and the proximal opening of the left side cylinder, and
wherein the cylinder wall of at least one of the right side cylinder or the left side cylinder comprises at least one return spring assembly, the return spring assembly comprising a return spring positioned in a spring chamber in the cylinder wall, the return spring having a proximal end and a distal end, the return spring assembly further comprising a barrel secured to the cylinder wall which extends laterally through the spring chamber and contacts a proximal end of the return spring; and
(2) a right side cut-covering assembly in an interior of the right side cylinder, comprising:
(a) a right side cut-covering conduit having an exterior surface, an interior surface, a proximal end adjacent the central chamber, a distal end, and a proximal portion between the proximal end and the distal end;
(b) a right side elastomeric seal having an exterior surface and an interior surface, wherein the exterior surface of the right side elastomeric seal contacts an interior surface of the right side cylinder and the interior surface of the right side elastomeric seal contacts the exterior surface of the right side cut-covering conduit; and
(c) a proximal sloped surface formed in or mechanically connected to the proximal side of the right side cut-covering conduit, wherein the sloped surface extends at an acute angle with respect to the vertical axis of the valve body and extends into the central chamber; and
(3) a left side cut-covering assembly in an interior of the left side cylinder, comprising:
(a) a left side cut-covering conduit having an exterior surface, an interior surface, a proximal end adjacent the central chamber, a distal end, and a proximal portion between the proximal end and the distal end;
(b) a left side elastomeric seal having an exterior surface and an interior surface, wherein the exterior surface of the left side elastomeric seal contacts an interior surface of the left side cylinder and the interior surface of the left side elastomeric seal contacts the exterior surface of the left side cut-covering conduit; and
(c) a proximal sloped surface formed in or mechanically connected to the proximal side of the left side cut-covering conduit, wherein the sloped surface extends at an acute angle with respect to the vertical axis of the valve body and extends into the central chamber;
wherein when the movable valve is moved vertically between a first position and a second position:
(a) a first side of the valve contacts the right side sloped surface of the right side cut-covering assembly and urges the distal end of the cut-covering assembly out of the distal opening of the right side cylinder,
(b) a second side of the valve contacts the left side sloped surface of the left side cut-covering assembly and urges the distal end of the cut-covering assembly out of the distal opening of the left side cylinder, and
(c) the barrel urges the proximal end of the return spring distally, thereby compressing the return spring.

2. The replacement valve of claim 1, wherein at least one of the right side cut-covering conduit and the left side cut-covering conduit is a split tube.

3. The replacement valve of claim 2, further comprising a diameter changing assembly comprising:
a guide slot formed in a distal portion of the split tube, the guide slot extending at an angle with respect to the longitudinal axis of the valve body in a distal portion of the split tube, and
a diameter guide pin secured to the cylinder wall and extending inwardly from the through the guide slot,
wherein when the split tube is urged distally, the diameter of the distal end of the split tube is expanded.

4. The replacement valve of claim 2, wherein both the right side cut-covering conduit and the left side cut-covering conduit are split tubes.

5. The replacement valve of claim 2, wherein the split tube has a cut along its entire length.

6. The replacement valve of claim 2, wherein the split tube has a cut extending from a medial portion of the split tube to the distal end of the split tube.

7. The replacement valve of claim 1, wherein both the right side cylinder and the left side cylinder comprise at least one return spring assembly.

8. The replacement valve of claim 1, wherein the replacement valve comprises a plurality of return spring assemblies.

9. The replacement valve of claim 1, further comprising a retaining plunger assembly, the retaining plunger assembly comprising a spring-loaded pin mounted in receiving chamber of a cylinder wall distal of the return spring, wherein when the distal end of the cut-covering assembly is moved out of the distal opening of the valve body cylinder to a predetermined extent, the spring-loaded pin is aligned with an opening in the cut-covering assembly and is urged through the opening, thereby locking the cut-covering assembly in place and preventing the cut-covering assembly from retracting.

10. The replacement valve of claim 1, wherein the proximal sloped surface of the left side cut-covering assembly, the right side cut-covering assembly, or both the left side cut-covering assembly and the right side cut-covering assembly is formed on a wheel mechanically connected to a respective cut-covering assembly.

11. The replacement valve of claim 1, wherein the moveable valve is a gate valve.

12. A method for replacing a valve in a pipe, the pipe containing fluid having an interior fluid pressure, comprising:
placing a housing in fluid-tight engagement with the pipe;
cutting a section of pipe, thereby creating a right side opening and a left side opening in the pipe, wherein the housing maintains the interior fluid pressure of the pipe;
advancing the replacement valve of claim 1 into the housing, wherein the right side cut-covering assembly is disposed within the right side opening of the pipe and the left side cut-covering assembly is disposed within the left side opening of the pipe;
placing the replacement valve and cut-covering assemblies into alignment with the right side opening and the left side opening of the pipe;
urging the vertically movable valve into the housing and thereby urging the elastomeric seal and the conduit of each cut-covering assembly into respective pipe openings; and releasing pressure within the housing, wherein the interior fluid pressure of the fluid in the pipe urges the elastomeric seal of each cut-covering assembly against the interior surface of a respective pipe and thereby seals the cut-covering assembly.
